(19) United States
(12) Patent Application Publication
(10) Pub. No.: US 2003/0081426 A1
(43) Pub. Date: May 1, 2003

(54) BRIGHTNESS ENHANCED HEAD LAMP APPARATUS

(76) Inventor: Sung Wu Lee, Banchiau City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/983,836

(22) Filed: Oct. 26, 2001

(51) Int. Cl. F21V 29/00

(52) U.S. Cl. 362/544; 362/228; 362/247

(57) ABSTRACT

A brightness enhancing device for an anti-dazzle head lamp of a car is disclosed. A neon lamp tube of a selective size is installed between the hyperboloid reflecting mirror and the head lens; or an inner periphery surface of the lens is coated with a layer of light focusing material. When a bulb of the lamp and the neon lamp tube is conductive, they light up at the same time. By the hyperboloid reflecting mirror, a surface of the whole head lens becomes very clear so as to achieve a safety driving.

### FIELD OF THE INVENTION

The present invention relates to a device to enhance the brightness for a dim lamp especially for an anti-dazzle head lamp of a car including to use a circular neon light tube of a selective size installed to an inner periphery a hyperboloid reflecting mirror and a head lens of the anti-dazzle head lamp or to use a layer of fluorescent material coated onto an inner periphery surface of the lens with an additional bulb disposed laterally there behind.

### BACKGROUND OF THE INVENTION

In general, only small lamps of a car are actuated in dusk for indicating the presence of the car. However, light emits from the small lamp is so weak so that it is often that people can not take sufficient attention to the light. As a consequence, some undesired accident occur as the people do not concentrate his (or her) attention. Therefore, the function of a small lamp is finite and can not attract sufficient attention by other drivers or walkers.

Therefore, there is an eager demand of a novel design which can improve aforesaid defect of the prior design.

### SUMMARY OF THE INVENTION

Accordingly, the primary object of the present invention is to provide an anti-dazzle head lamp having an additional lighting element which is a neon lamp tube. A neon lamp tube of a selective size is installed between the hyperboloid reflecting mirror and a head lens of a csr. When a bulb of the lamp and the neon lamp tube is conductive, they light up at the same time. By the hyperboloid reflecting mirror, a surface of the mirror and lens becomes very clear so that the safety in driving is achieved.

Another object of the present invention is to provide an anti-dazzle head lamp, wherein used a layer of fluorescent material coated onto an inner periphery surface of the lens with an additional bulb disposed laterally there behind. A light source is placed between the hyperboloid reflecting mirror and the lens. The fluorescent material emits light as light is absorbed. When two bulbs are conductive and light up. The fluorescent material in the mirror will enhance the light intensity so that the whole head lens surface will glare. Hereby, a safety driving is achieved.

A further object of the present invention is to provide an anti-dazzle head lamp, wherein an inner periphery of the surface of the lens is coated with a layer of light focusing material. As power of the bulb is conductive and then lights up, focusing of the mirror is enhanced. Therefore, a safety driving is achieved.

The various objects and advantages of the present invention will be more readily understood from the following detailed description when read in conjunction with the appended drawing.

### BRIEF DESCRIPTION OF THE DRAWINGS

FIG. 1A is a schematic view of the mounting structure of the present invention.

FIG. 1B is a perspective view of a small lamp of the present invention.

FIG. 1C is a sectional view of a small lamp of the present invention.

FIG. 2 is a schematic view showing the configuration of the present invention.

FIG. 3 is a schematic view showing another configuration of the present invention.

### DETAILED DESCRIPTION OF THE PREFERRED EMBODIMENTS

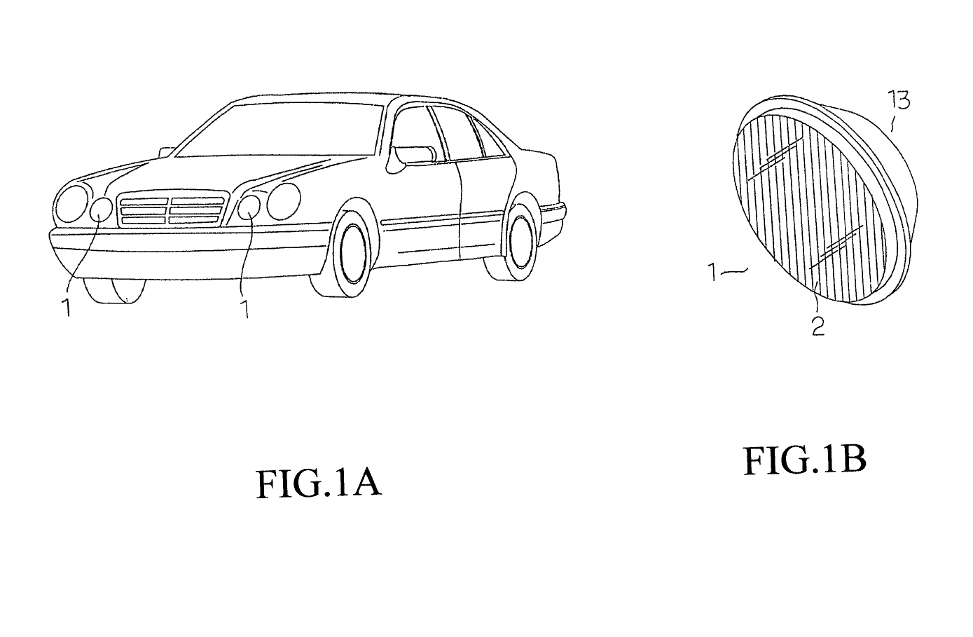

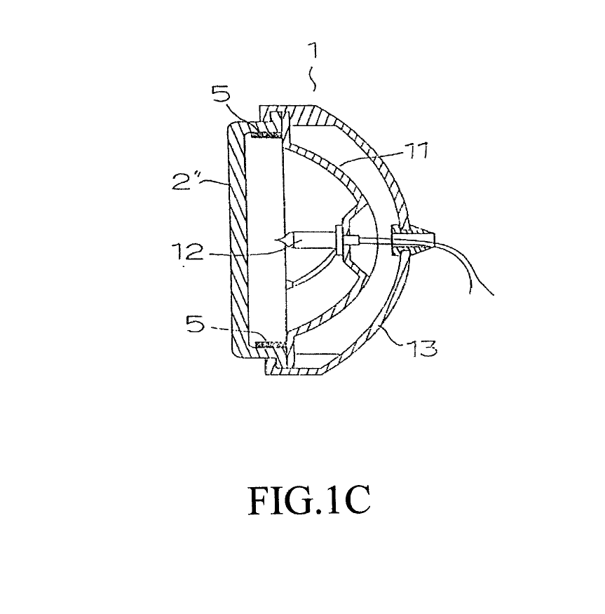

Referring to FIGS. 1A, 1B, 1C and FIG. 2, the anti-dazzle head lamp of a car used in a vehicle is illustrated, the anti-dazzle head lamp is suitable in various lamp seats. In general, the seat 1 is formed by a housing 13 with a hyperboloid reflecting mirror 11. Thereby, a bulb 12 is placed in the center portion thereof. Then, a head lens 2 is installed at an outer periphery of the housing 13. Therefore, when the bulb 12 is conductive and lights up, the light projects to the hyperboloid reflecting mirror 11 will be focused to the head lens 2 so as to achieve the object of alert and illumination. The feature of the present invention is that a neon tube 3 with a size identical to the edge of the lamp frame is installed between the hyperboloid reflecting mirror 11 and the head lens 2 of the seat 1, as illustrated in FIG. 2. When the bulb 12 and the neon lamp tube 3 are conductive, it lights up at the same time. By the hyhperboloid reflecting mirror 11, the surface of the whole mirror 11 becomes very clear so that the incoming drivers of cars or motorcycles and walkers can be clearly displayed on the head lens. Therefore, the possibility of accident is reduced.

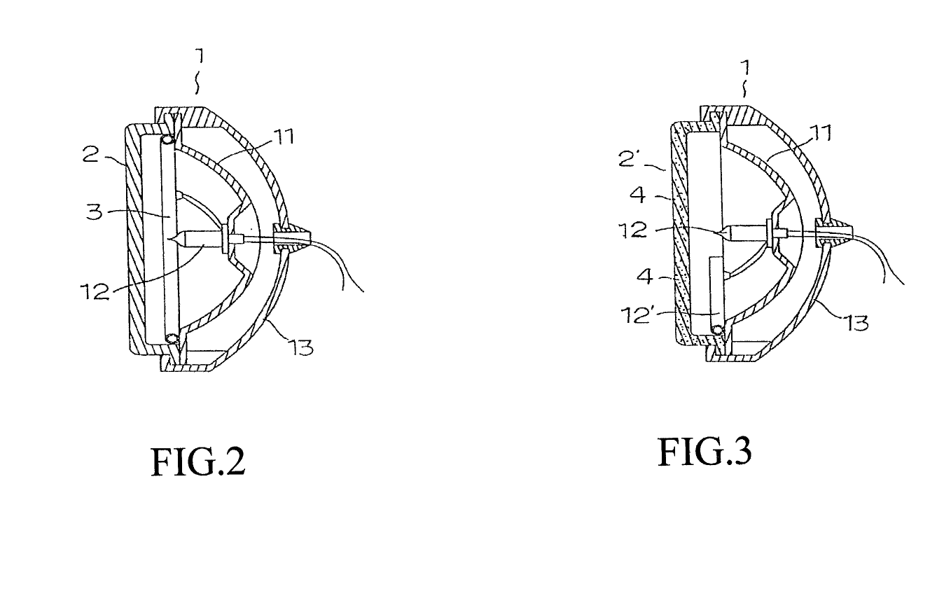

Moreover, the whole seat 1 and head lens 2′ are contained with fluorescent material 4. Furthermore, a light source 12′ is placed between the hyperboloid reflecting mirror 11 and the head lens 2′, as illustrated in FIG. 3. The fluorescent material may emit light as light is absorbed. When the two bulbs 12 and 12′ are conductive and light up, the fluorescent material in the head lens 2′ will enhance the light intensity so that the whole head lens surface will glare. Thereby, the incoming cars or motorcycles and walkers will take attention to the car. Since a small lamp lights up, other walker may take care of the car, so that a safety driving is achieved.

In summary, no matter what methods described above are used, the objects of alert and increasing the safety in driving are achieved. Therefore, the present invention is helpful to the traffic safety. The hurt due to carelessness can be reduced.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A brightness enhancing device for an anti-dazzle head lamp of a car which will be used during a device at dust or dawn for which indicating the presence of the car consists of an additional lighting element disposed between a hyperboloid reflecting mirror and a head lens of said anti-dazzle head lamp and operated by the driver to enhancing the brightness therefore.

2. A brightness enhancing device for an anti-dazzle head lamp of a car according to claim 1 wherein said additional lighting element is a neon tube of selective size been installed between a hyperboloid reflecting mirror and a head lens thereof and a head lens thereof and head lamp and operated by the driver to enhancing the brightness thereof.

3. A brightness enhancing device for an anti-dazzle head lamp of a car according to claim 1 wherein said additional lighting element is an additional bulb of selective size been installed between a hyperboloid reflecting mirror and a head lens thereof and a head lens thereof and head lamp and operated by the driver to enhancing the brightness thereof.
